(19) United States
(12) Patent Application Publication
(10) Pub. No.: US 2020/0220945 A1
(43) Pub. Date: Jul. 9, 2020

(54) A METHOD FOR CREATING A PRE-DEFINED VIRTUAL MOBILEPHONE PROFILE ENVIRONMENT

(71) Applicant: PRIVACY SOFTWARE SOLUTIONS LTD., Hod-Hasharon (IL)

(72) Inventors: Tzachi ZACK, Shoham (IL); Lior NAVEH, Hod-Hasharon (IL); Udi DOENYAS, Kibbutz Einat (IL)

(21) Appl. No.: 16/648,145

(22) PCT Filed: Sep. 17, 2018
(86) PCT No.: PCT/IL2018/051052

§ 371 Date: Mar. 17, 2020

Related U.S. Application Data
(60) Provisional application No. 62/559,678, filed on Sep. 18, 2017.

(51) Int. Cl. H04L 29/08

(52) U.S. Cl. CPC H04L 67/306; H04L 67/42; H04L 67/34

(57) ABSTRACT

System and method for creating a pre-defined virtual mobile phone profile environments in one or more mobile phones, according to which a domain module is generated in a server side which is a computing unit, thereby creating an administrator and a user console. Unique context is generated and uploaded for each domain and managing the context by an administrator and the unique context is stored for each domain on the domain module, which is adapted to store a user-profile data representing at least one set of user-preferences of at least one user and a plurality of entity-profile data of a person of respective entities. An installation file is generating for specific operation system, APK, for each domain, allowing a user to download the installation file into the user mobile phone, to thereby generate a pre-defined second environment, corresponding to the domain. Then a virtual layer is created in a client side by generating a container in the kernel and using operation system tasks and services to simulate a complete second virtual environment.

### FIELD OF INVENTION

The present invention relates to the field of mobile smartphones applications for virtually defining a second (or more) profile environment within the same smartphone unit. More specifically, the present invention relates to the field of virtualization of mobile environment by pre-defining said profile environment in a separate computing unit and downloads it to the designated mobile smartphone.

### BACKGROUND OF INVENTION

An organization or a person may be interested in defining their own profile-template of virtual mobile phone environment as a second phone environment within their own personal, customers or employees existing smartphone units. This pre-defined template profile of mobile phone environment can also have a second phone number (Direct Inward Dialings or DIDs, which allows a company to assign a personal number to each employee or user, without requiring a separate physical phone line, for each, to connect to the PBX) for second identification, outgoing and incoming phone calls and text messages.

For example, a company might want to create its own profile of virtual mobile phone environment with its own applications, themes, settings, phone numbers etc. The company administrator creates and defines the profile-template virtual mobile phone environment within a server based interface. Once this profiled virtual mobile phone environment is ready, it can be downloaded as a complete virtual smartphone solution to the end user's mobile phone. The administrator can choose to upload the profiled virtual mobile phone environment as configuration of a generic package, or as a full pre-compiled package to the organization's application server or official application store, public application store (e.g. Google Play Store), send a link to the end user with a code by SMS or any other application distribution method (i.e. mail, WhatsApp etc.)

It therefore an object of the present invention to provide a system and a method for pre-defining a profile environment in a separate computing unit and downloading it to a designated mobile smartphone.

Other objects and advantages of the invention will become apparent as the description proceeds.

### SUMMARY OF THE INVENTION

In one aspect the invention relates to a method for creating a pre-defined virtual mobile phone profile environments in one or more mobile phones, comprising:
a. generating in a server side a domain module which is a computing unit thereby creating an administrator and a user console;
b. generating and uploading unique context for each domain and managing said context by an administrator;
c. storing said unique context for each domain on said domain module, which is adapted to store a user-profile data representing at least one set of user-preferences of at least one user and a plurality of entity-profile data of a person of respective entities; and
d. Generating an installation file for specific operation system, APK, for each domain, allowing a user to download said installation file into said user mobile phone, to thereby generate a pre-defined second environment, corresponding to said domain;
e. creating a virtual layer in a client side by generating a container in the kernel and using operation system tasks and services to simulate a complete second virtual environment.

In an embodiment of the invention, each domain unique context is installed in the user mobile phone as a mobile application.

In an embodiment of the invention, the computing unit is further adapted to determine:

the location area of a user;

the timing of each number and environment to be activated;

the applications, themes, background, second phone number, settings, a PBX management, pre-defined rules and restrictions and private application store.

In an embodiment of the invention, the user-preferences comprise data representing parameters of the geographical area.

In an embodiment of the invention, the method further comprises receiving information about a second phone environment encapsulation.

In an embodiment of the invention the method for creating an additional virtual environment, further comprises the steps of:
a. creating an additional phone environment to eliminate the need to use two physical phones;
b. adding a new phone number on the same smart phone environment module;
c. associating the additional environment with new user accounts such as emails and social application; and
d. associating the newly added phone number to text messaging accounts such as SMS's and WhatsApp.

In an embodiment of the invention the method further comprising the step of registering said user to said additional environment.

In an embodiment of the invention the method comprising the step of specifying parameters of the geographical area by said user.

In an embodiment of the invention the method comprising the step of specifying parameters of the scheduling access timing by said user.

In another aspect the invention relates to a system for creating a pre-defined virtual mobile phone profile environment in one or more mobile phones based on a client-server environment, comprising:
a) a server side in a separate computing unit, for hardware virtualization of said one or more mobile phones adapted to perform the following:
   i. user accounts management;
   ii. pre-configuring applications, contacts, themes, widgets, restriction based on a specific template-profile;
   iii. Virtual phone lines management;
   iv. PBX and signaling of calls;
   v. Central security heuristics;
   vi. Issuing management reports: statistics for technical, accounting and marketing purposes;
   wherein in said computing unit a domain module is generated to create an administrator and a user console for generating uploading and storing unique context for each domain and enabling managing said context by an administrator; and wherein an installation file for specific operation system, APK, for each domain, is generated for allowing a user to download said installation file into said user mobile phone, to thereby generate a pre-defined second environment, corresponding to said domain;
b) a client side with a mobile device and mobile application which acts as a semi-virtual machine over supported mobile device models, wherein a virtual layer is created in said client side by generating a container in the kernel and using operation system tasks and services to simulate a complete second virtual environment; and
c) communication lines between said client side and said server side.

In an embodiment of the invention, hardware virtualization of each mobile phone is based on pre-defined settings which reside on the server side or on a cloud service with external API.

In an embodiment of the invention, the system further comprising additional embedded phone line number/s.

In an embodiment of the invention, a new template-profile is created and is a pre-configured virtual smartphone environment with settings, application, contacts, themes, widgets, phone line, specific content, restriction based on the said Profiled Virtual Smartphone through administrator or personal interface over cloud, or by building an environment from scratch over a basic, minimal environment on a prototype administrator smartphone, and uploading the created template-profile onto the administrator cloud.

In an embodiment of the invention, user can then download from the cloud any specific profiled template as a ready-made, configured virtual smartphone environment.

In an embodiment of the invention, a new identity is provided for each user, that is associated with a new phone number (MSISDN) so another set of social media and communications Applications can be used, have another SMS and dialer, protect private chats/photos and any activity done in said additional virtual smartphone environment.

In an embodiment of the invention, in the additional virtual environment, said plurality of entity-profile data represents at least two different types of profiles of respective different entities.

In an embodiment of the invention, in the additional virtual environment, said user-preference includes data representing parameters of the geographical area. The additional virtual environment of claim 6, wherein each of said entities is embodiable by one of the following: a private entity and a business entity, an overt entity and hidden entity.

### BRIEF DESCRIPTION OF THE DRAWINGS

FIG. 1 is a schematic block diagram illustration of a pre-defined virtual mobile phone profile, according to an embodiments of the invention.

The drawings taken with the descriptions thereof make apparent to those skilled in the art how the invention may be embodied in practice.

Further, where considered appropriate, reference numerals may be repeated among the figures to indicate identical elements.

### DETAILED DESCRIPTION OF THE EMBODIMENTS OF THE INVENTION

The present invention relates to a computing server (back-end environment) and a mobile smartphones application for virtually adding a pre-defined second environment within the same smartphone unit. In embodiments of the invention, the system comprises a computing unit which is separate from the smartphone unit, and which is adapted to store therein, inter alia: user-profile data representing at least one set of user-preferences of at least one user; and a plurality of entity-profile data of a person of respective entities. The computing unit may further be adapted to determine the location area of the person. The computing unit may further be adapted to determine the timing of each number and environment to be activated, for example: a first environment which is activated during work hours and a second environment which is activated after work hours (also referred to as scheduling system).

In order to create a user profile a domain is created and all the definition s are added to this domain including all the user preferences application setting definition a virtual phone number and the like. The user profile may be defined by a theme, for example, Disney profile, to which all the Disney content is added, the background of the virtual phone is with Disney's characters, all the applications related to Disney are in the virtual phone environment and the songs from Disney's films are added to the virtual phone environment. The whole environment is created in the domain and once it is completed an execute file is created and the application is ready to be downloaded by a user to his smartphone. The file may be added by the user or by an administrator and it can also be upgraded.

Another example can be taken from the dating world—to create a virtual mobile phone for dating environment. In this user profile all the application related to dating will be added to the profile user, some as build in applications and some as optional applications according to the user's request. An additional phone number may be given to handle phone calls received through the virtual environment and the whole user profile environment is adapted to the dating theme.

The application and system creates an extra virtual layer of one or more personalized phone environment(s) within an existing phone, to eliminate the need to carry two or more device phones.

The virtual layer is created by generating a container at the kernel (basic operation system level) and using operation system tasks and services to simulate a complete second virtual environment. At the user interface level, it looks and feels like a regular operation system environment with the ability to run any application and tasks like the real operation system.

One of the main advantages of the invention is in the concept that changes in the profile in the back-end are sent to the client and transforming the client to the desired profile changes on the fly.

In an embodiment of the invention, the system comprises a back-end, server based system that enables the administrator to define multiple profiles of virtual mobile phone environments that includes applications and/or themes and/or background and/or a second phone number, and/or settings, and/or PBX management and/or pre-defined rules & restrictions and/or private application store.

In an embodiment of the invention, the method creates a pre-defined virtual mobile phone profile environments in one or more mobile phones. In the first step the system generates a plurality of mobile applications to be virtually added to an inherent mobile environment of a mobile phone, which adds a pre-defined second environment within each of the one or more mobile phones;

In the second step the system stores the plurality of mobile applications on a computing server, which is adapted to store a user-profile data representing at least one set of user-preferences of at least one user and a plurality of entity-profile data of a person of respective entities; and at the third step, the system allows each user to download one or more mobile applications into his mobile phone, to thereby generate a pre-defined second environment, corresponding to said one or more mobile applications.

The virtual template-environment may also be associated with a new phone number so all duplicated or new applications' accounts that are generated in this environment, can be associated to this phone number while a new virtual identity is being created within the new complete environment.

The system of the present invention comprises a computing server (back-end environment) and a mobile smartphones application for virtually adding a pre-defined second environment within the same smartphone unit. In an embodiment of the invention, the system comprises a computing unit, which is adapted to store therein, inter alia: user-profile data representing at least one set of user-preferences of at least one user; and a plurality of entity-profile data of a person of respective entities. The computing unit may further be adapted to determine the location area of the person. The computing unit may further be adapted to determine the timing of each number and environment to be activated (also referred to scheduling system).

In embodiments of the invention, the back-end computing unit may determine the applications, themes, background, a second phone number, settings, A PBX management, pre-defined rules and restrictions and private application store.

In embodiments of the invention, the user-preferences may comprise data representing parameters of the geographical area.

In embodiments of the invention, the machine-readable medium may further perform the step of receiving information about the second phone environment encapsulation.

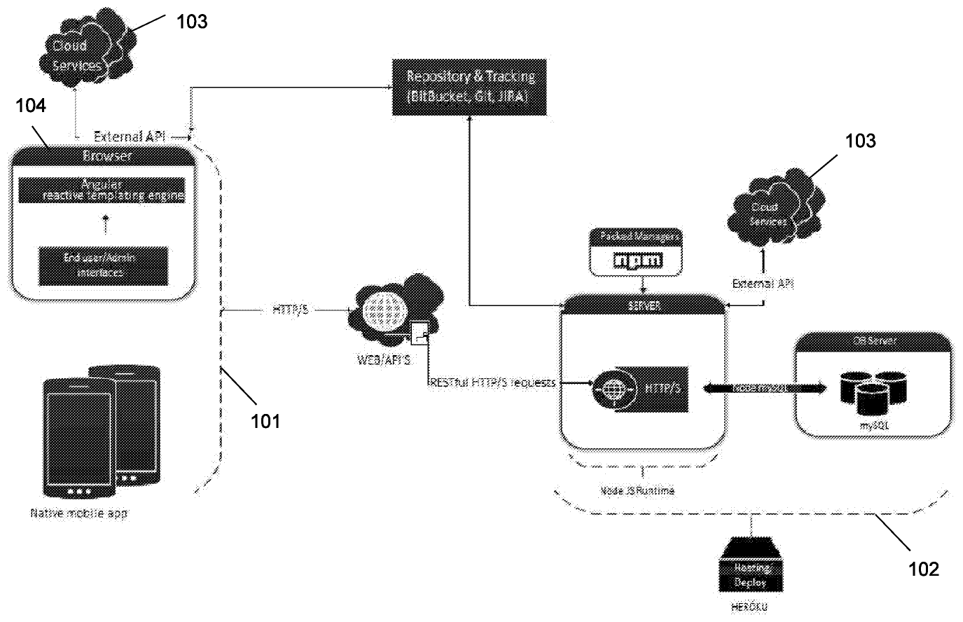

As shown in FIG. 1, the system consists of a client-server environment which includes a client side and a server side. The client side 101 comprises a mobile application which acts as a semi-virtual machine (Apps launcher or Container) over supported mobile phone models. The server side 102 is responsible for:
User accounts management;
pre-configuring applications, contacts, themes, widgets, restriction based on a specific template-profile.
Virtual phone lines management
PBX and signaling of calls
Central security heuristics
Issuing management reports: statistics for technical (e.g. load), accounting and marketing purposes

The system performs hardware virtualization of each mobile phone, based on pre-defined settings which reside on the server side.

Based on the virtual phone personalization, the following modules are generated:
1) Domain. i.e. like in the above example a domain https://disney.space.com is generated and a user/admin console is created.
2) Unique context for each domain. This context is managed by the super admin console which controls all the modules.
3) Installation file for the specific operation system aka APK (Android or iOS). This file is the actual installation file that runs on the client's device.
4) Dedicated application store with the recommended applications for the user, blacked listed application, pre-installed applications and list of applications that already installed on the main user phone.
5) Dedicated Phone numbers (lines) list and configuration

The back-end system and the client side are communicating with dedicated API (Application Program Interface) which are part of this invention. The user profile are set with the API and are communicated using any data peer (Internet)

The system is based on a cloud service with external API 103. It runs on a web browser 104, based on AngularJS (a JavaScript-based open-source front-end web application framework The AngularJS framework works by first reading the HTML page, which has additional custom tag attributes embedded into it. AngularJS interprets those attributes as directives to bind input or output parts of the page to a model that is represented by standard JavaScript variables. The values of those JavaScript variables can be manually set within the code, or retrieved from static or dynamic JSON resources) with end-user/admin interfaces.

In an embodiments of the invention, the back-end computing unit may determine the applications, themes, background, a second phone number, settings, a PBX management, pre-defined rules & restrictions and private application store.

In an embodiments of the invention, the user-preferences may comprise data representing parameters of the geographical area.

In embodiments of the invention, the machine-readable medium may further perform the step of receiving information about the second phone environment encapsulation.

In the aforementioned system, one may define the applications store that will be used, how the end-user predefined environment looks like (background, widgets, applications and restrictions). It is possible to determine that the pre-defined virtual phone will be delivered to the end user by linking to official application store, private link and security method.

1. A method for creating a pre-defined virtual mobile phone profile environments in one or more mobile phones, comprising:
a) generating in a server side a domain module which is a computing unit thereby creating an administrator and a user console;
b) generating and uploading unique context for each domain and managing said context by an administrator;
c) storing said unique context for each domain on said domain module, which is adapted to store a user-profile data representing at least one set of user-preferences of at least one user and a plurality of entity-profile data of a person of respective entities; and
d) generating an installation file for specific operation system, APK, for each domain, allowing a user to download said installation file into said user mobile phone, to thereby generate a pre-defined second environment, corresponding to said domain;
e) creating a virtual layer in a client side by generating a container in the kernel and using operation system tasks and services to simulate a complete second virtual environment.

2. A method according to claim 1, wherein each domain unique context is installed in the user mobile phone as a mobile application.

3. A method according to claim 1, wherein the computing unit is further adapted to determine:
a) the location area of a user;
b) the timing of each number and environment to be activated;
c) the applications, themes, background, second phone number, settings, a PBX management, pre-defined rules and restrictions and private application store.

4. A method according to claim 1, wherein the user-preferences comprise data representing parameters of the geographical area.

5. A method according to claim 1, further comprising receiving information about a second phone environment encapsulation.

6. A system for creating a pre-defined virtual mobile phone profile environment in one or more mobile phones based on a client-server environment, comprising:
a. a server side in a separate computing unit, for hardware virtualization of said one or more mobile phones adapted to perform the following:
i. user accounts management;
ii. pre-configuring applications, contacts, themes, widgets, restriction based on a specific template-profile;
iii. Virtual phone lines management;
iv. PBX and signaling of calls;
v. Central security heuristics;
vi. Issuing management reports: statistics for technical, accounting and marketing purposes;
wherein in said computing unit a domain module is generated to create an administrator and a user console for generating uploading and storing unique context for each domain and enabling managing said context by an administrator; and wherein an installation file for specific operation system, APK, for each domain, is generated for allowing a user to download said installation file into said user mobile phone, to thereby generate a pre-defined second environment, corresponding to said domain;
b. a client side with a mobile device and mobile application which acts as a semi-virtual machine over supported mobile device models, wherein a virtual layer is created in said client side by generating a container in the kernel and using operation system tasks and services to simulate a complete second virtual environment; and
c. communication lines between said client side and said server side.

7. A system according to claim 6, wherein hardware virtualization of each mobile phone is based on pre-defined settings which reside on the server side or on a cloud service with external API.

8. A system according to claim 6, further comprising additional embedded phone line number/s.

9. A system according to claim 6, wherein a new template-profile is created and is a pre-configured virtual smartphone environment with settings, application, contacts, themes, widgets, phone line, specific content, restriction based on the said Profiled Virtual Smartphone through administrator or personal interface over cloud, or by building an environment from scratch over a basic, minimal environment on a prototype administrator smartphone, and uploading the created template-profile onto the administrator cloud.

10. A system according to claim 7, wherein user can then download from the cloud any specific profiled template as a ready-made, configured virtual smartphone environment.

11. The system according to claim 6, wherein a new identity is provided for each user, that is associated with a new phone number so another set of social media and communications Applications can be used, have another SMS and dialer, protect private chats/photos and any activity done in said additional virtual smartphone environment.

12. The system according to claim 6, wherein in the additional virtual environment said plurality of entity-profile data represents at least two different types of profiles of respective different entities.

13. The system according to claim 6, wherein in the additional virtual environment said user-preference includes data representing parameters of the geographical area.

14. The system according to claim 6, wherein in the additional virtual environment each of said entities is embodiable by one of the following: a private entity and a business entity, an overt entity and hidden entity.

15. A method according to claim 1, for creating an additional virtual environment, said method comprising the steps of:
a. creating an additional phone environment to eliminate the need to use two physical phones;
b. adding a new phone number on the same smart phone environment module;
c. associating the additional environment with new user accounts such as emails and social application; and
d. associating the newly added phone number to text messaging accounts such as SMS's and WhatsApp.

16. The method of claim 15, further comprising the step of registering said user to said additional environment.

17. The method of claim 15, comprising the step of specifying parameters of the geographical area by said user.

18. The method of claim 15, comprising the step of specifying parameters of the scheduling access timing by said user.
